(19) United States
(12) Patent Application Publication
(10) Pub. No.: US 2007/0020386 A1
(43) Pub. Date: Jan. 25, 2007

(54) Encapsulation of chemically amplified resist template for low pH electroplating

(76) Inventors: Daniel W. Bedell, Gilroy, CA (US); John W. Lam, San Jose, CA (US); Matthew W. Last, San Jose, CA (US); Kim Y. Lee, Fremont, CA (US); Jyh-Shuey Lo, San Jose, CA (US); Dennis R. McKean, Milpitas, CA (US); Chun-Ming (Albert) Wang, Fremont, CA (US); Yi Zheng, San Ramon, CA (US)

Correspondence Address: WAGNER, MURABITO & HAO, LLP, TWO NORTH MARKET STREET, THIRD FLOOR, SAN JOSE, CA, 95113, US

(21) Appl. No.: 11/186,166

(22) Filed: Jul. 20, 2005

(51) Int. Cl. B05D 5/12; B05D 5/00; B05D 1/36; B05C 11/02

(52) U.S. Cl. 427/128; 427/402; 427/282; 118/52

(57) ABSTRACT

Systems and methods for encapsulation of chemically amplified resist template for low pH electroplating are disclosed. In a first method embodiment, a resist template structure is formed on a wafer. Substantially all surfaces of the resist template structure are encapsulated to form an encapsulated structure. Magnetic materials are plated onto the encapsulated structure.

### TECHNICAL FIELD

Embodiments of the present invention relate to the fields of manufacturing semiconductors and hard disk drives, and more particularly to systems and methods for encapsulation of chemically amplified resist template for low pH electroplating.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model was established approximately 50 years ago and resembles a phonograph. That is, the hard drive model includes a plurality of storage disks or hard disks vertically aligned about a central core that spin at a standard rotational speed. A plurality of magnetic read/write transducer heads, for example, one head per surface of a disk, is mounted on the actuator arm. The actuator arm is utilized to reach out over the disk to or from a location on the disk where information is stored. The complete assembly, e.g., the arm and head, is known as a head gimbal assembly (HGA).

In operation, the plurality of hard disks is rotated at a set speed via a spindle motor assembly having a central drive hub. Additionally, there are channels or tracks evenly spaced at known intervals across the disks. When a request for a read of a specific portion or track is received, the hard disk drive aligns a head, via the arm, over the specific track location and the head reads the information from the disk. In the same manner, when a request for a write of a specific portion or track is received, the hard disk drive aligns a head, via the arm, over the specific track location and the head writes the information to the disk.

Over the years, refinements of the disk and the head have provided great reductions in the size of the hard disk drive. For example, the original hard disk drive had a disk diameter of 24 inches. Modern hard disk drives are generally much smaller and include disk diameters of less than 2.5 inches (micro drives are significantly smaller than that).

The recording or read/write heads of modern hard disk drives do not actually make contact with the recording media. Rather the heads “fly” on a cushion of air generated by the relative motion of the head over a rapidly spinning platter or disk comprising the recording media. The ability of a head to fly at a desirable height is a critical performance aspect of hard disk drives. Such flying heads are generally referred to or known as “sliders.” As recording density increases, the slider flying height, e.g., the distance between a slider and a recording media surface, generally decreases. Such decreases in flying height typically require ever-flatter slider surfaces. A lapping process typically determines a flatness characteristic of a slider.

A wafer is a basic “building block” upon which numerous processing actions take place to produce multiple components. Wafers form such a building block for the production of magnetic read and/or write heads (“sliders”) as used in hard disk drives. The production of such devices can comprise many different processing steps. It is not uncommon for hundreds of operations to be performed on wafers to produce magnetic heads. In recording head technology, the volume or size of the recording sensor is very small. For example, modern recording, or write heads are of the order of 100 nm. Typically, such sensors become ever smaller with successive generations of hard drive technology.

The on-going increase in areal recording density and corresponding size reduction for read and write heads is driving head manufacturing processes toward higher resolution deep ultra violet photolithography. For example, deep ultra violet light, e.g., light with a wavelength of about 248 nm, can image smaller structures with greater precision than light with a longer wavelength, e.g., approximately 360 nm. In addition, the same trends towards ever smaller head sizes and feature dimensions is also driving a trend towards the use of “stronger” magnetic materials in the construction of such heads. For example, smaller heads will generally advantageously utilize materials characterized by a greater magnetic moment than is characteristic of larger heads.

The use of deep ultra violet photolithography generally correspondingly requires the use of chemically amplified resist materials, while the use of higher magnetic moment materials generally necessitates plating in very low pH (highly acidic) baths. Unfortunately, chemically amplified resist materials are generally not well suited to very low pH plating baths. For example, chemically amplified resist materials, especially low activation and hybrid types, are generally inherently unstable in an acidic environment. Stresses in thick chemically amplified resist materials induced by low pH plating baths can cause fractures and shrinkage in the resist layers, resulting in “worms.” Such worms or cracks can undermine adhesion of the resist layers, resulting in deleterious under plating of head structures.

### SUMMARY

Accordingly, there is a need for systems and methods for encapsulation of chemically amplified resist template for low pH electroplating. Additionally, in conjunction with the aforementioned need, systems and methods for encapsulation of chemically amplified resist template for low pH electroplating that enable decreased head feature dimensions are desired. A further need, in conjunction with the aforementioned, is for encapsulation of chemically amplified resist template for low pH electroplating in a manner that is compatible and complimentary with existing wafer processing systems and manufacturing processes.

Accordingly, systems and methods for encapsulation of chemically amplified resist template for low pH electroplating are disclosed. In a first method embodiment, a resist template structure is formed on a wafer. Substantially all surfaces of the resist template structure are encapsulated to form an encapsulated structure. Magnetic materials are plated onto the encapsulated structure.

In accordance with another embodiment of the preset invention, a magnetic head comprises a metal plating layer and a chemically amplified resist structure. An encapsulating layer is disposed between the chemically amplified resist structure and the chemically amplified resist structure for protecting the chemically amplified resist structure from the metal plating layer.

### BRIEF DESCRIPTION OF THE DRAWINGS

FIG. 1 is a schematic of an information storage system comprising a magnetic hard disk file or drive for a computer system, in accordance with embodiments of the present invention.

FIGS. 2A, 2B, 2C, 2D, 2E and 2F illustrate stages of a wafer being processed to achieve encapsulation of a chemically amplified resist template for low pH electroplating, in accordance with embodiments of the present invention.

FIG. 3 illustrates a method for plating, in accordance with embodiments of the present invention.

### BEST MODES FOR CARRYING OUT THE INVENTION

Reference will now be made in detail to the alternative embodiment(s) of the present invention, systems and methods for encapsulation of chemically amplified resist template for low pH electroplating. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

In the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

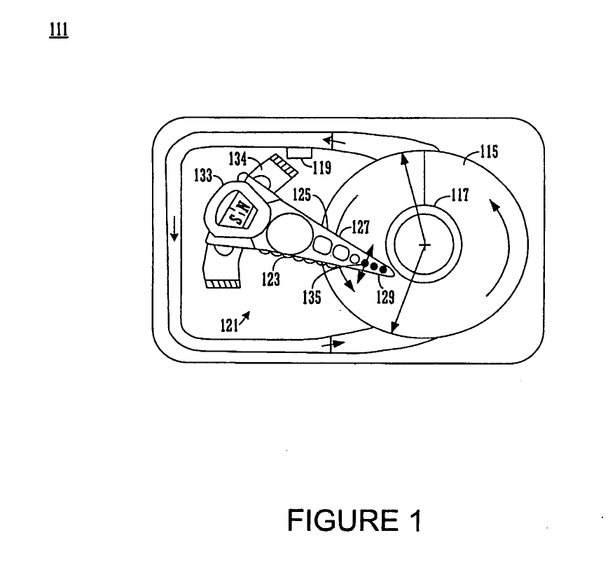

FIG. 1 is a schematic drawing of an information storage system comprising a magnetic hard disk file or drive 111 for a computer system, in accordance with embodiments of the present invention. Drive 111 has an outer housing or base 113 containing a disk pack having at least one media or magnetic disk 115. A spindle motor assembly having a central drive hub 117 rotates the disk or disks 115. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered load beam and suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly is head and the slider 129, which are mounted on suspension 127. The slider 129 is usually bonded to the end of suspension 127. The head is typically pico size (approximately 1250×1000×300 microns) and formed from ceramic or intermetallic materials. The head also may be of “femto” size (approximately 850×700×230 microns) and is pre-loaded against the surface of disk 115 (in the range two to ten grams) by suspension 127.

Suspensions 127 have a spring-like quality, which biases or urges the air-bearing surface of the slider 129 against the disk 115 to cause the slider 129 to fly at a precise distance from the disk. A voice coil 133 free to move within a conventional voice coil motor magnet assembly 134 (top pole not shown) is also mounted to arms 125 opposite the head gimbal assemblies. Movement of the actuator 121 (indicated by arrow 135) by controller 119 moves the head gimbal assemblies along radial arcs across tracks on the disk 115 until the heads settle on their respective target tracks. The head gimbal assemblies operate in a conventional manner and move in unison with one another, unless drive 111 uses multiple independent actuators (not shown) wherein the arms can move independently of one another.

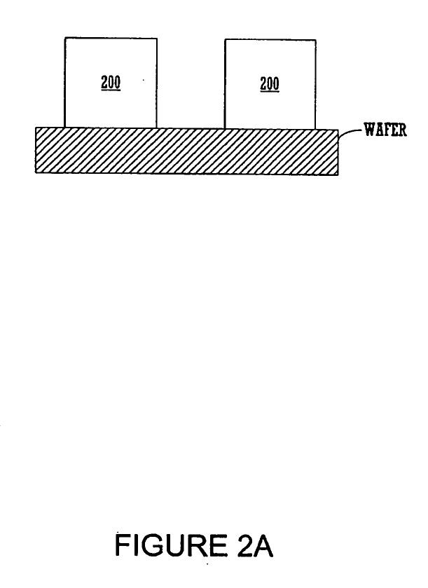

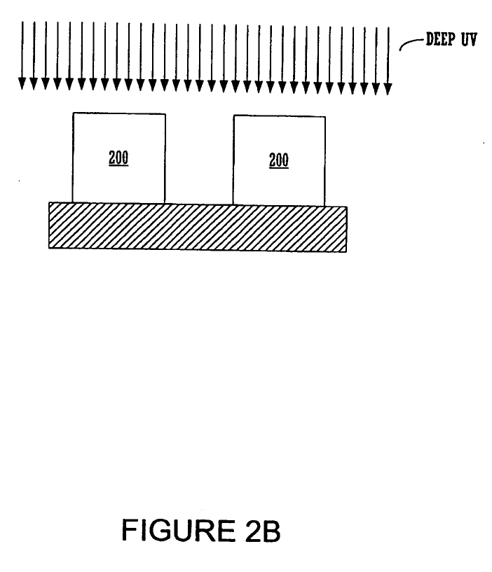

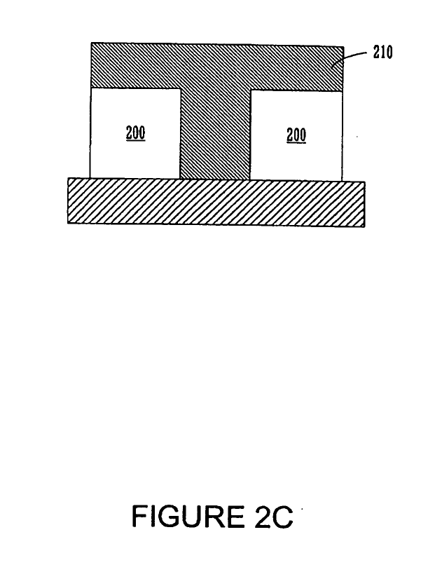

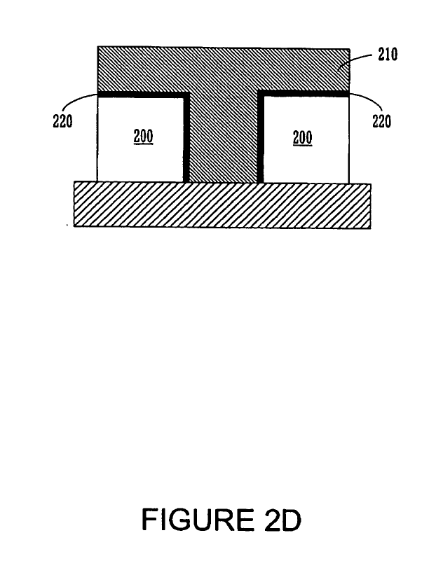

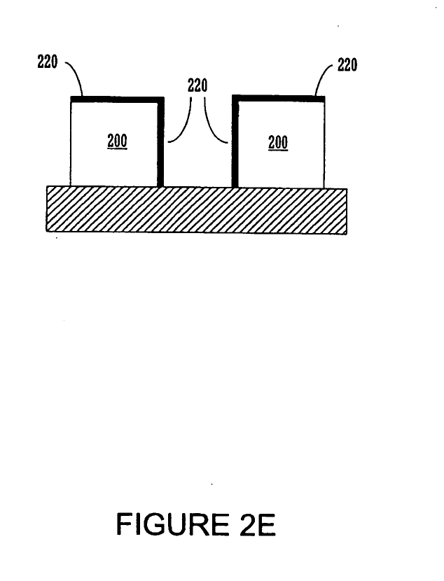

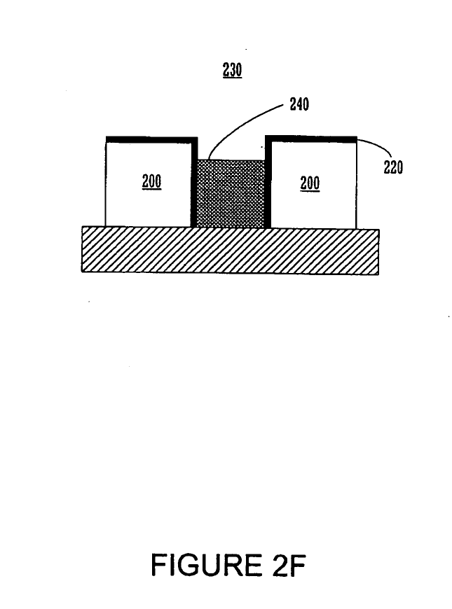

FIGS. 2A through 2F illustrate stages of a wafer being processed to achieve encapsulation of a chemically amplified resist template for low pH electroplating, in accordance with embodiments of the present invention. Such a structure can be utilized in the construction of a magnetic head, in accordance with embodiments of the present invention. In FIG. 2A, a resist template structure 200 is applied to a wafer surface via well-known means. The resist template structure 200 may comprise a chemically amplified resist (CAR) material, in one embodiment.

In FIG. 2B, the wafer with the photolithographic resist template structure 200 is exposed to a “flood exposure” of deep ultra violet light energy, for example at a wavelength of about 248 nm, in accordance with embodiments of the present invention. For example, a “flood exposure” generally exposes substantially all of a surface. After the flood exposure, residual photoacid is present on the surfaces of chemically amplified resist template structure 200.

In FIG. 2C, a coating of a polymer bonding material 210 is applied to the wafer and chemically amplified resist template structure 200, for example via a spin-on process, in accordance with embodiments of the present invention. Exemplary polymer bonding materials may include process chemicals utilized in the process known as “Resolution Enhancement Lithography Assisted by Chemical Shrink,” commercially available under the trademark RELACS® from AZ Electronic Materials of New Jersey.

FIG. 2D illustrates results of a mixing bake operation, in accordance with embodiments of the present invention. The polymer bonding material 210 utilizes a cross linking reaction catalyzed by an acid component existing in chemically amplified resist template structure 200, e.g., the aforementioned photoacid. As a result of such a mixing bake operation, polymer bonding material 210 forms a cross-linked polymer layer 220 into the surfaces of chemically amplified resist template structure 200. In accordance with an embodiment of the present invention, the cross-linked polymer layer 220 is about 50 nm thick.

In FIG. 2E, the majority residue of polymer bonding material 210 is rinsed off, in accordance with embodiments of the present invention. For example, that portion of polymer bonding material 210 that has not cross-linked with chemically amplified resist template structure 200 is removed by rinsing. It is to be appreciated that cross-linked polymer layer 220 remains after the rinsing. Cross-linked polymer layer 220 overcoats and encapsulates the chemically amplified resist template structure 200.

It is to be appreciated that the conventional use of a polymer bonding material, e.g., the RELACS® process, is to shrink a feature, e.g., a hole diameter or trench width, to a size less than the critical dimension (CD) of the process. A cross-linked polymer layer on the interior of such a hole effectively shrinks the diameter of such a hole (width of a trench). In a conventional use of a polymer bonding material, a deep ultra-violet “flood exposure” of the patterned photoresist film is not performed. Thus only the vertical surfaces of the pattern have sufficient acid concentration to form a cross-linked polymer layer. Consequently, horizontal surfaces do not react with polymer bonding materials to form a cross-linked polymer. As such, conventional usage of polymer bonding materials does not produce cross-linked polymer layers across an entire resist structure.

In contrast to the conventional art, embodiments in accordance with the present invention expose an entire resist structure, e.g., chemically amplified resist template structure 200, to deep ultra violet light energy. Consequently, substantially all surfaces of a resist structure are coated with polymer bonding materials, and cross-linked polymer layers are formed on substantially all such surfaces. Such cross-linked polymer layers are utilized to provide an encapsulating layer of protection for subsequent low pH electroplating.

FIG. 2F illustrates an electroplated structure 230, in accordance with embodiments of the present invention. Electroplated structure 230 comprises an electroplating layer 240, cross-linked polymer layer 220 and chemically amplified resist template structure 200. An exemplary composition of an electroplating layer 240 is 22 percent nickel (Ni) and 78 percent iron (Fe). It is to be appreciated that electroplating such a large portion of iron (Fe) generally requires a highly acidic plating solution.

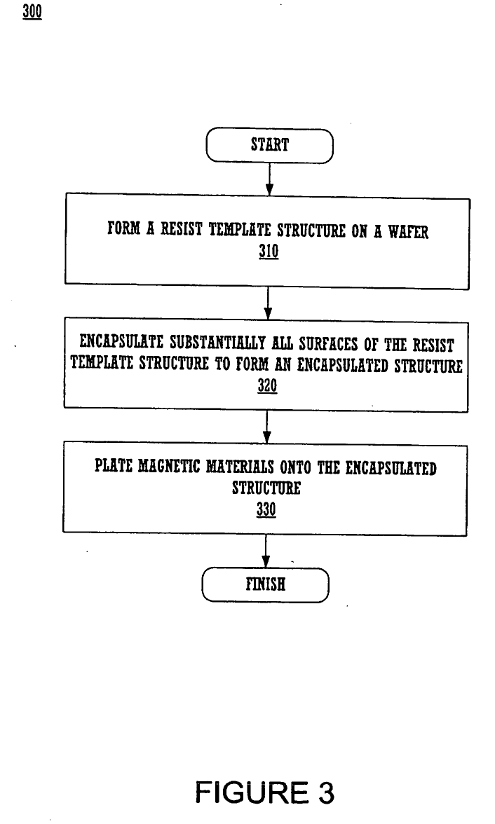

FIG. 3 is a flow chart of a method 300 for plating, in accordance with embodiments of the present invention. In 310, a resist template structure is formed on a wafer via well-known means. For example, the resist template structure 200 of FIG. 2A can be formed in 310. The resist template structure may comprise chemically amplified resist materials.

In 320, substantially all surfaces of the resist template structure are encapsulated to form an encapsulated structure. The encapsulated structure can comprise a cross-linked polymer. Cross-linked polymer layer 220 of FIG. 2E illustrates an exemplary encapsulated structure.

In 330, magnetic materials are plated onto the encapsulated structure, forming a pre-head structure. See, for example, electroplated structure 230 of FIG. 2F. The plating process can comprise an acidic plating solution. The magnetic materials can comprise iron (Fe). The magnetic materials can further comprise a compound of a majority of iron (Fe).

In optional 340, the pre-head structure is processed to form a magnetic head. Such processing of a pre-head structure into a magnetic head is well suited to a variety of well known methods.

Thus, embodiments of the present invention provide an apparatus and method of encapsulation of chemically amplified resist template for low pH electroplating. Additionally, in conjunction with the aforementioned benefit, embodiments of the present invention provide systems and methods for encapsulation of chemically amplified resist template for low pH electroplating that enable decreased head feature. A further benefit, in conjunction with the aforementioned benefits, encapsulation of chemically amplified resist template for low pH electroplating is provided in a manner that is compatible and complimentary with existing wafer processing systems and manufacturing processes.

While the method of the embodiment illustrated in flow chart 300 shows specific sequences and quantity of operations, the present invention is suitable to alternative embodiments. For example, not all the operations provided for in the methods are required for the present invention. Furthermore, additional operations can be added to the operations presented in the present embodiment. Likewise, the sequences of operations can be modified depending upon the application.

Embodiments in accordance with the present invention, encapsulation of chemically amplified resist template for low pH electroplating, are thus described. While the present invention has been described in particular embodiments, it should be appreciated that the present invention should not be construed as limited by such embodiments, but rather construed according to the below claims.

What is claimed is:

1. A method of plating comprising:
forming a resist template structure on a wafer;
encapsulating substantially all surfaces of said resist template structure to form an encapsulated structure; and
plating magnetic materials onto said encapsulated structure.

2. The method of claim 1 wherein said resist template structure comprises chemically amplified resist materials.

3. The method of claim 1 wherein said encapsulated structure comprises a cross-linked polymer.

4. The method of claim 3 wherein said cross-linked polymer is substantially continuous over said resist template structure.

5. The method of claim 1 wherein said plating utilizes an acidic plating solution.

6. The method of claim 1 wherein said magnetic materials comprise iron (Fe).

7. The method of claim 6 wherein said magnetic materials comprise a compound of a majority of iron (Fe).

8. A method of forming a magnetic head comprising:
forming a resist template structure on a wafer;
encapsulating substantially all surfaces of said resist template structure to form an encapsulated structure;
plating magnetic materials onto said encapsulated structure to form a pre-head structure; and
processing said pre-head structure to form said magnetic head.

9. The method of claim 8 wherein said resist template structure comprises chemically amplified resist materials.

10. The method of claim 8 wherein said encapsulated structure comprises a cross-linked polymer.

11. The method of claim 8 wherein said cross-linked polymer is substantially continuous over said resist template structure.

12. The method of claim 8 wherein said plating utilizes an acidic plating solution.

13. The method of claim 8 wherein said magnetic materials comprise iron (Fe).

14. The method of claim 13 wherein said magnetic materials comprise a compound of a majority of iron (Fe).

15. A means for plating comprising:
means for forming a resist template structure on a wafer;
means for encapsulating substantially all surfaces of said resist structure template to form an encapsulated structure; and
means for plating magnetic materials onto said encapsulated structure.

16. The means of claim 15 wherein said means for forming a resist template resist template structure comprises chemically amplified resist materials.

17. The means of claim 15 wherein said means for encapsulating comprises cross-linked polymer means.

18. The means of claim 17 wherein said cross-linked polymer means are substantially continuous over said resist template structure.

19. The means of claim 15 wherein said means for plating utilizes an acidic plating solution.

20. The means of claim 15 wherein said magnetic materials comprise a compound of a majority of iron (Fe).
